(19) United States
(12) Patent Application Publication
(10) Pub. No.: US 2015/0242538 A1
(43) Pub. Date: Aug. 27, 2015

(54) METHOD AND SYSTEM FOR DEVELOPING APPLICATIONS FOR CONSULTING CONTENT AND SERVICES ON A TELECOMMUNICATIONS NETWORK

(71) Applicant: ABLE FRANCE, Suresnes (FR)

(72) Inventor: Sofiane Bendiabdallah, Marnes La Coquette (FR)

(21) Appl. No.: 14/386,474

(22) PCT Filed: Mar. 18, 2013
(86) PCT No.: PCT/FR2013/050572

§ 371 Date: Feb. 2, 2015

(30) Foreign Application Priority Data
Mar. 19, 2012 (FR) 1252441

(51) Int. Cl. G06F 17/30

(52) U.S. Cl. CPC G06F 17/30997; G06F 17/30864; G06F 17/30598

(57) ABSTRACT

A method is proposed for an application for consulting, on an apparatus provided with a display screen, content and services accessible by browsing the web, from a computer operated by a user and connected to an applications server. In response to the selection by the user of information and/or content on the web during a web clickstream, metadata comprising data description and location information and corresponding to the selected information and/or content, is recorded and grouped in a data structure of the application. A software agent capable of extracting information and/or content from the web on the basis of the metadata provides presentation data of the information and/or content extracted from the web.

### RELATED APPLICATIONS

The present application is a National Phase entry of PCT Application No. PCT/FR2013/050572, filed Mar. 18, 2013, which claims priority from FR Patent Application No. 1252441, filed Mar. 19, 2012, said applications being hereby incorporated by reference herein in their entirety.

### BACKGROUND OF THE INVENTION

The present invention relates to the field of personal applications for accessing content and services located on one or more telecommunications networks. It relates more particularly to methods and systems for creating, developing, modifying, distributing, installing, sharing, and using one or more custom programs or applications on one or more devices connected to a telecommunications network such as the Internet or an Intranet, private or open, for the purposes of using or accessing information and/or services according to selection and presentation criteria specific to each user. To simplify the discussion, only the terms “Internet” and “the web” will be used below, but the invention applies equally and without limitation to private networks and intranets.

There is currently a wide variety of devices allowing users to take advantage of information and services on the Internet: personal computers (laptops and desktops), terminals, tablets or e-readers (with touchscreens), mobile touchscreens (high-end phones or handheld devices or personal digital assistants) connected to the Internet via the network of a mobile network operator or via wireless access, certain telephones and videophones, television set-top boxes, as well as televisions and vehicle on-board computers.

This list is not exhaustive, and other devices may be added to it as new telecommunications services and devices are provided. These include objects connected in so-called “machine to machine” architectures.

The most commonly used tool for accessing information and which is present on most of these devices is the browser, which integrates a large number of technologies for interpreting almost all of the functions and services offered on the sites visited, such HTML, Java, Flash, etc. It is possible to install applications in addition to the browser, usually dedicated to a type of service, that can offer a more suitable interface for the device while allowing access to information on the Web. Some even include a browser window for when the user selection is oriented towards data not provided by the application. We are therefore seeing a gradual convergence of the above two modes of access.

There is a lot of information available on the Internet. To facilitate searching for information, there are general search engines (for example known by the names Google, Yahoo, Baidu, etc.) or vertical search engines (directories, comparators in activities such as real estate, tourism, employment, cars, hobbies, games).

User requirements usually concern searches for information or content about products or services, comparisons of products or services (features, prices, consumers reviews), and searches concerning documents or literature, breaking news, online shopping, etc. This list is not exhaustive.

Users are accustomed to spending time first in a search session that requires expressing their requirements, which can be imprecise and often difficult, then in an access session where the user may want to save information for later use. If this is the case, this information is usually retrieved by copying and pasting and is often stored in files and folders which must be organized if they are to be retrievable later on. However, this information quickly becomes obsolete and must be updated.

The “general search” browser mentioned above has the disadvantage of leaving it up to the user to search for the sources of information that interest him, to manage these sources (using bookmarks) when he decides to revisit them repeatedly, and sometimes to download information in more or less significant quantities (entire pages), even if he is only interested in a small category of information. This is the case, for example, for comparisons of products or services between multiple providers, real estate listings, etc.

There are also applications that are developed for web sites (called “server applications”) which make use of bots to collect and aggregate information from multiple sources (breaking news, job postings, comparators, etc.) in order to present them in the browser as a normal page. These applications require the expertise of developers specializing in server site tools and application programming interfaces (API). These skills are not within the grasp of just any user.

Lastly, there are applications developed specifically for devices, which make use of the specific characteristics of the hardware and operating system. They are often more efficient. However, they also require developer skills to create them, as well as powerful and complex development and distribution tools. Some of them handle the collection and presentation of information on the web in a more useful manner than with a browser (for stock information, weather, used items for sale, real estate for sale or lease, etc.). However, similarly to server applications, these are developed specifically for a particular service, requiring specific skills including knowledge of application programming interfaces (API) and are often only an enhanced version of the Web pages of the service, thereby excluding information from competing services. They are also not within the grasp of just any user.

These applications frequently do not correspond to all the actual needs of the user. Their interface is imposed by the service and the developer, and does not take into account the personal tastes of users. Users also want comparisons of information from different services, which is rarely addressed in a satisfactory manner. Ideally, each user would be able to implement his own applications on demand. But, as noted above, such development requires a lot of time, specialized skills, and developer experience.

### SUMMARY OF THE INVENTION

The present invention seeks to overcome these disadvantages by allowing all users of the web (or intranet), whether or not they are experts, to access and use data and services of interest in the manner appropriate for them, in a simple and practical fashion.

One object of the invention is to allow each user, without any special developer skills, to create his own applications for accessing the web simply and easily, according to his needs and his information presentation and selection criteria, on any devices available to him (computer, cell phone, tablet, TV, etc.).

Another object of the invention is to allow each user to modify, improve his own applications according to his experience and to his changing needs.

Another object of the invention is to allow users to share applications or parts of applications made by other users, and in particular to reuse an existing application without needing to create it, as well as to modify it, enhance it as desired, or integrate a module created by another user in accordance with predefined access and authorization rules.

To this end, a method for developing an application for accessing on a device provided with a display screen, content and services accessible by browsing the web, from a computer operated by a user and connected to an applications server, is proposed according to a first aspect of the invention. The proposed method comprises: capturing, in response to the selection by the user of information and/or content on the web during a web clickstream, metadata comprising data description and location information and corresponding to the selected information and/or content, and recording said metadata, and grouping in a data structure of the application the metadata, a software agent capable of extracting information and/or content from the web on the basis of the metadata, and presentation data for the information and/or content extracted from the web.

Metadata is understood here to be the set of criteria needed to find the data in the web page or in another page of similar structure, usually by means of agents and bots.

In some embodiments, the method for developing an application further comprises recording a web clickstream of the user, the software agent being adapted to reproduce the recorded clickstream.

In some embodiments, the method for developing an application further comprises selecting from among a plurality of presentation templates an application frame designed for displaying, on the display screen of the device on which the application is executed, information and/or content extracted from the web, with the data structure of the application comprising the application frame selected.

In some embodiments, the method for developing a custom application further comprises: running an application execution program on the computer, establishing a connection between the application execution program running on the computer and the applications server, running the software agent stored in the data structure of the application in order to extract the information and/or content selected by the user during his clickstream on the basis of the application metadata, adapting according to the presentation data associated with the application the information and/or content extracted by the software agent, and displaying the adapted information and/or content on the display screen of the computer.

According to another aspect, the invention proposes an application development system comprising a computer comprising a processor and a memory coupled to the processor, and a recording server coupled to an applications database, wherein the memory stores a set of software comprising a web browser and a specific development plug-in for the browser for developing an application intended to be run on a device provided with a display screen, wherein the specific development plug-in for the browser comprises instructions for performing: (i) the capture and transmission to the recording server, in response to the selection by a user of information and/or content on the web during a web clickstream, of metadata comprising data description and location information and corresponding to the selected information and/or content, wherein the recording server is configured to execute software comprising instructions for, during an application development session, receiving and recording metadata corresponding to the information and/or content selected, generating a software agent capable of extracting information and/or content from the web on the basis of the metadata, receiving and recording presentation data for the information and/or content extracted from the web, and grouping and saving in a data structure of the application the metadata, the software agent, and the presentation data.

In a particular embodiment of the application development system, the specific development plug-in for the browser further comprises instructions for redirecting, to the recording server, navigation requests and responses from the browser corresponding to the user clickstream, and the software of the recording server further comprises instructions for recording a user clickstream on the web.

In a particular embodiment of the application development system, the software of the recording server further comprises instructions for capturing metadata corresponding to data of the same or similar type as the data selected by the user in the same page of the visited site, as well as in other pages of the site.

The user can therefore advantageously construct a very complete application in a very simple manner, from only a small number of selections.

In a particular embodiment of the application development system, the software of the recording server further comprises instructions for sharing metadata and/or some or all of the applications database between users, to enable users to share applications in order to create/modify and execute applications.

Thus, according to particular embodiments of the invention, the sharing means are combined with the applications database to enable sharing some or all of the applications when such sharing is permitted. The users who benefit from this can advantageously modify some or all of the shared applications for their own use. They can also modify the prototype application templates available to them in order to adapt them to their own specific requirements. It is also possible to construct sophisticated applications by combining applications from multiple users.

With these arrangements, the sharing of metadata and similar structures allows effortlessly enriching and enhancing the applications.

In a particular embodiment of the application development system, the specific development plug-in for the browser comprises a module for interfacing between the different types of software agent for managing the applications metadata and the various interface technologies for acquisition and rendering provided on the target devices of the applications.

In a particular embodiment of the application development system, the set of software that is the browser and the specific development plug-in for the browser is an integrated development application.

In a particular embodiment, the application development system further comprises a user subscription server, a database of users and user spaces, and means for sharing applications between users according to relevant rights.

In a particular embodiment, the application development system further comprises a means for searching semantic analogies of metadata in order to augment the automatic extraction of metadata during creation or modification of an application.

### BRIEF DESCRIPTION OF THE DRAWINGS

Other features, objects, and advantages of the invention can be deduced from the following description, intended to be purely illustrative and non-limiting, with reference to the accompanying drawings in which:

FIG. 1 depicts a first operating mode of the invention, for the creation of an application by a user,

FIG. 2 depicts a second operating mode of the invention, for the modification of an existing application,

FIG. 3 shows the general architecture of the means used to implement the invention,

FIG. 4 shows the steps of the application recording method,

FIG. 5 shows the structure of an application recording,

FIG. 6 shows an embodiment of the application recording server,

FIG. 7 shows an embodiment of the browser plug-in,

FIG. 8 shows an embodiment of a system for recording, distributing, and sharing applications, according to the invention.

### DETAILED DESCRIPTION OF THE DRAWINGS

For better understanding of the following description, certain technical terms are first defined:
Device: These are devices that are or can be connected to the web (Internet or Intranet) and are capable of executing at least one application, such as: desktop, laptop, tablet, e-reader (tablet dedicated to reading e-books), mobile phone with screen (known as a smartphone), javaphone (phone with an operating system based on Java), television or set-top box for digital TV, on-board computer (in a car, on a bike, on a pedestrian). This list is not exhaustive, as other devices are likely to exist in the near future. Each user can have one or more devices. A common but non-limiting feature of these devices is that they contain: one or more means of interaction such as screen, keyboard, mouse, voice command and speaker, or touch surface; a central processing unit; and an operating system. Their means for displaying and interaction may possibly be provided remotely on other devices via a telecommunications link. They have the capacity to accept applications, either downloaded or pre-installed (before delivery to the user). This list can also be extended to home automation systems intended for more specific purposes (security monitoring, weather, programmable automation, etc.) and to machines that are part of a distributed “machine to machine” type architecture.
Applications, Browser: Applications (application software) are programs launched by the user. The most common application for accessing information on the web is the browser. This is widely used to provide access to virtually all types of information. It is often supplemented with plug-ins to perform one or more tasks or functions that were not originally provided for.

There are also many applications dedicated to only one type of information (stock prices, movie schedules, online stores, airline/train/taxi reservations, etc.) that have been developed exclusively for that purpose.

There are various technologies for implementing these applications: native applications that run on the device independently, and online applications that run on a server site on the web and are accessible to the device via the browser.

The present invention relates to a new type of applications, that is, to hybrid applications, consisting of a resident part called the “execution program” that runs on the device, and a remote part that runs online on a server site; the two parts cooperate via a telecommunications network, in particular so that the first (execution program) displays the data sent by the second in response to user actions.
Metadata: Structured set of information describing a resource. A web page consists of structured data presented graphically in standardized components. Metadata are not data, but descriptions of data or criteria serving to identify and describe the web information and more generally any information resource and all types of elements (text, image, video, sound) including interactive elements (input boxes, lists, forms, dialogs, buttons, links, etc.). They serve to tag these resources and allow better interoperability between sources such as (list is not exhaustive):
Content: title, subject, description, source, language, relation, coverage.
Intellectual property: creator, publisher, contributor, rights (copyright . . . ).
Implementation: date, type, format, identifier.
   These data are dynamic, meaning they change over time, while metadata remain constant. It should also be noted that two web pages accessible at different addresses may have data of similar structure but containing different values. The metadata therefore do not contain the values but the means of accessing these values using bots and automated agents for which these metadata are constructed and recorded. Metadata reach their full potential in the semantic web. The latter is based on general web standards (HTTP protocol, URI, XML) and on standards specific to the semantic web (Resource Description Framework (RDF)), μformats: this reference framework contains graph templates for formally describing web resources and their metadata, to allow the automatic processing of such descriptions).
Record: element of a file or database. In the present description, a record contains one or more agents, bots and metadata.
Agent (software) and bots: In computing, an agent is the software equivalent of a robot. It is a program that performs automated tasks similarly to a programmable logic controller, on the basis of what it is asked to do. Traditionally, an agent controls one or more bots, with the bots executing basic tasks. The bots use the metadata to access the data.

In a web context, intelligent agents are linked to the semantic web, where they are used in place of humans for performing searches and correlations between search results. This is done according to predefined rules. They are capable of a certain degree of autonomy, particularly in communicating among themselves.
Proxy, Proxy Server: This is a component that sits between two other components to facilitate or monitor their exchanges. A proxy server is set up to ensure the operation of the applications server that is the object of the invention. The term “server” is relative to all centralized or distributed architectures, including “peer to peer” architectures. Proxy servers are used in particular for the following functions:
speeding up browsing: cache, data compression, content filtering;
logging searches and recording responses;
local network security, filtering and anonymity.

The above definitions are given for information only and are not to be considered as limiting.

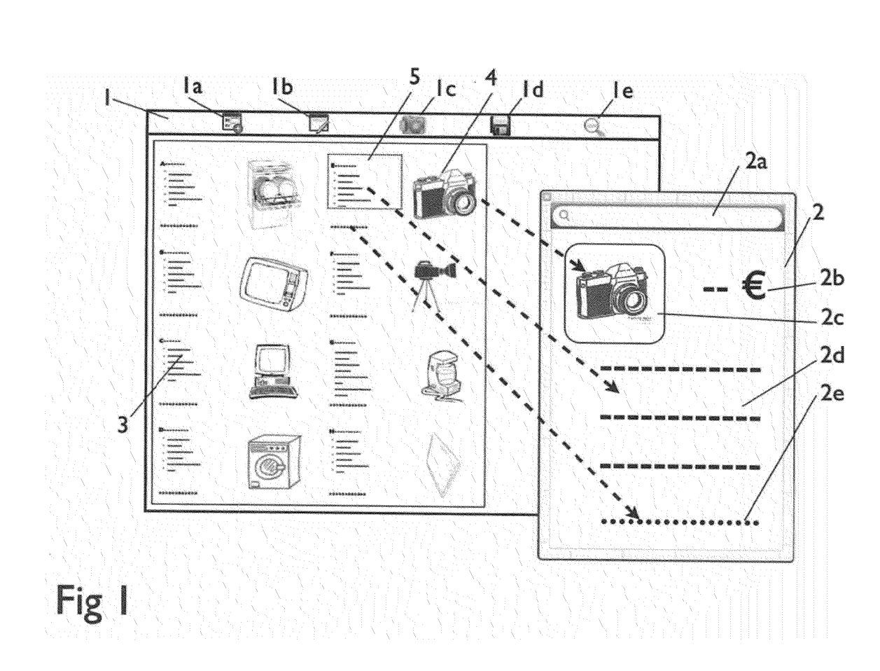

FIG. 1 depicts a first simplified operating mode intended to illustrate the aim of the invention in the creation of a simple application by an ordinary user.

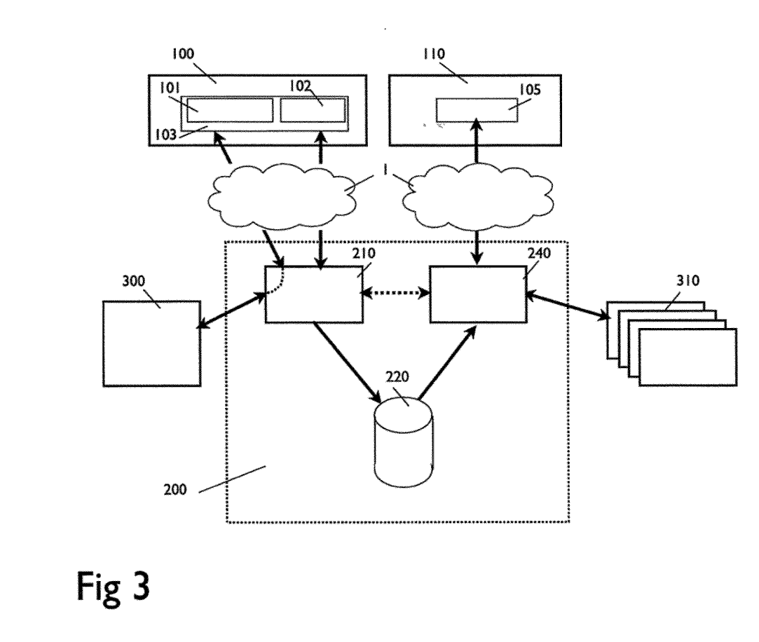

To more easily understand the invention, a description of this usage scenario from the user's perspective allows presenting the basic principles satisfying the aims of the invention. This makes it easier to understand the architecture and components of the system described below in relation to FIG. 3.

A user wants to build a mini-application for use on one or more devices (computer, tablet, phone, PDA, or TV) in order to explore a particular area of information (in this case commercially available cameras, in preparation for a purchase for example). This concerns a catalog of devices, consisting of sheets which each show a photo of the product, its price, its features, and user reviews, as well as a search tool. It could also contain a comparison and links to the respective merchant sites, but this is not shown.

To achieve this aim, the user launches a browser on his personal computer, which displays a first standard window 1 in which he can view a page 3 of a website that he has previously searched, for example by means of one of the known search engines.

To create this mini-application, the browser has a preinstalled plug-in that adds functionality. This plug-in is assumed to have been preinstalled, for example at the time of registration with the application creation server site described below, which the application needs to run. The site offers the downloading and installation of this plug-in in a known manner, just after user registration, like any other application download.

The combination of browser+plug-in may be replaced by an application that integrates these two features beforehand, for example when the computer is preloaded with this application.

It should also be noted that it is possible to use a tablet or any other equivalent device instead of a computer, as long it provides equivalent functionality, even in other forms (for example, a touch screen can be equivalent to a mouse).

One of the key changes introduced by this plug-in is to redirect web traffic through the applications server site. This redirection is an existing configuration function of the browser which is used by the plug-in when it is launched.

In this simplified example, the plug-in displays a specific menu bar with control buttons for performing additional functions beyond those of the browser:
a button 1a for creating a new application,
a button 1b for modifying an existing application,
a button 1c for selecting an item,
a button 1d for saving the end of the operations,
a button 1e for viewing the result in a simulation window.

The number of buttons and corresponding functions is limited here for clarity, but other buttons are possible depending on the desired level of enhancement. These buttons are designed to send commands to the applications server, which is not shown in this figure but is described below in relation to FIG. 3, by means of the redirection of traffic mentioned above.

By clicking button 1a, a “view” or application window or “application frame” 2 is created and displayed. This is an empty prototype of the mini-application.

More advantageously, it is a predefined template ready to be filled in. Before the creation of this window, it is assumed that the server will have proposed an application theme to the user from among a set of pre-existing themes, similarly to many applications currently available. By choosing a theme, the user also chooses the type(s) of devices on which the application to be created can run. In the example shown, it is assumed that the user has selected a catalog of product sheets, each sheet designed to contain an image of the product 2c, a price 2b, a list of features of the product 2d, user reviews 2e, and a field 2a for searching all the sheets.

To fill in this application frame, the user first starts by searching the web for a product of the desired type. For example, he goes to the site of a retailer that offers a catalog of products of a specific brand. He spots an image 4 of a camera that he selects with the mouse for example, by defining a box around the object or by holding the button in a long click. This action is sent to the server, which can then identify the image. To indicate to the user that the image has been identified by the server, the image is highlighted by known means such as a semi-transparent mask, a border, or blinking. The user can then drag and drop the image 4 from the page 3 to the image area 2c of the prototype 2. He continues in a similar manner with the other parts of the sheet, by a dragging and dropping the selected text of the features 5 from the page 3 to the features area 2d of the prototype 2, and continues in this manner for the price 2b and user reviews 2e sections.

At each selection by the user, the server retrieves the corresponding metadata and stores them in a database of metadata (described below in relation to FIG. 3).

The invention is not limited to the selection of static objects such as those mentioned above. It also allows selecting objects providing actions such as calculation buttons, navigation buttons, action buttons, dialogs, input fields, lists, forms, displayed results of actions, etc.

Once a sheet is created, it is saved and another sheet can be created. The process continues in this manner until the user has stored all objects of interest to him.

During the process, the user can modify an object using button 1b (for example the size and position of an object on the sheet, using his mouse or a touchpad).

The test button 1e provides the option of launching the application in dynamic simulation mode in order to judge the quality of the result. It allows making full use of the application created in the frame 2 as if it had been downloaded in its final form. This allows the user to see whether the application and the objects automatically extracted from the web by the server meet his expectations.

At the end of these operations, the user clicks the “Save” button 1d and the application is finalized automatically by the server. The application is then ready for use on the device or devices specified by the user in the manner explained below in relation to FIG. 3.

This application is then executed according to the representation chosen at creation (window 2), but has become an application independent of the browser, capable of displaying product sheets from among a list of sheets, with interactive navigation and enhanced with a simple search tool.

The application downloaded to the device from the server contains a part that is resident on the device but does not contain any dynamic data. The resident part takes care of the functionalities specific to the device, such as the functions of telecommunication, display, rendering of images, audio and video, and user interactions. The sheets are filled in using the metadata stored on the server during creation and the data are retrieved from the web page at the time of access, using these same metadata. The data are thus always up to date and are successfully extracted even if their location has changed on the original site.

Of course, the sheets described in this example can be enhanced with other features such as rankings based on certain criteria, links to websites that could activate the opening of a browser window or the launching of another mini-application.

The saved application could be strictly for individual use but could also be shared with other users who in this case can reuse some or all of the application frame and its functionality. Indeed, as discussed below, the data extraction performed by the server can be shared. A simple application can thus inherit the efforts of other users and become much richer.

We thus can see that very little effort is required to create an application, which is the object and main advantage of the invention. This advantage is due to the separation and cooperation between the applications server and the browser plug-in used during creation. The wealth of possible applications arises from the wealth of templates proposed (which can be added to by users), and the possibilities for reusing and modifying existing applications. The greater the number of users, the greater the wealth of applications resulting from the imagination of users who thus contribute to developing the service.

Moreover, the browser plug-in can of course provide a greater number of functions and buttons (not shown in the figure) for the graphical construction and enhancement of the application, according to known technologies, such as for example:
a “Multiple selection” button to alert the plug-in and the server that the page being accessed contains multiple objects of the same type and that the server is to extract them automatically when only one of these objects is selected. The selection of a single object can therefore lead to the automatic creation of several sheets.
a “Style” button that allows changing interface aspects such as color, style, and font size, for all or part of the set of data linked to the metadata, meaning applicable to all similar records.
A “Grid” button that allows easily positioning objects in the view according to a predefined alignment.
A “Refresh” button for refreshing the view and therefore the data and content extracted from the metadata, to ensure that the information in the view corresponds to what is on the web.
A “Background” button for showing the area where the metadata is added.
A “Layers” button that allows working with multiple parts of the application independently, or creating different results in the same area depending on the user clickstream (for example a stock price is represented as either the current value of the stock or as a graph of its history, depending on the context when executing the application, etc.). This clickstream can be viewed during creation by selecting the “layers” button which provides a simple way of toggling the meaning of the area modifiable by copy/paste or drag/drop.
A “Change” button that allows modifying the saved recording or the chosen template.
A “Share” button that allows sharing some or all of the application frame and its associated tools. It defines the permissions for other users to access the recorded metadata. This allows others to take, copy, modify, and/or enhance the application.
A “Source” button that allows the user to find the web page where the metadata was captured.
A “Frame” button that switches the actions of a user from one application frame to another application frame if multiple frames are created or open simultaneously.
A “Help” button that allows the user to find help when creating the application. An agent, for example, asks questions when there are choices (when the machine cannot decide for him).

In this manner, a person who knows how to use a browser can create his application entirely with the mouse or by touching a touchscreen. We will see below how these simple operations also result in the automatic creation of complex agents in the applications server. These agents offload the data-related operations from the device.

While the previous example shows a simple application offering one frame, it is clear that the invention also makes it possible to create more complex applications by assembling multiple frames or simple applications, each occupying a “sub-frame” or section of the application frame.

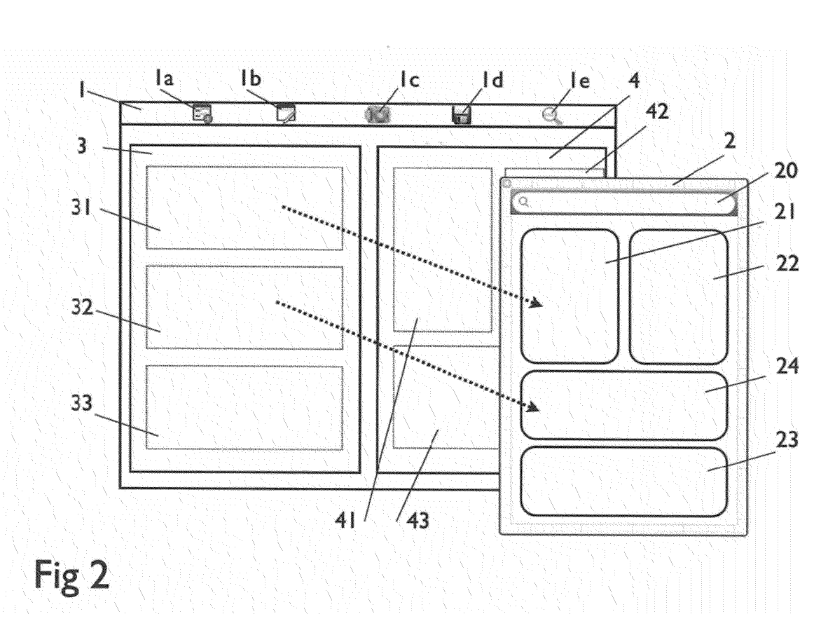

The example of FIG. 2 relates to such an application. It shows an alternative operating mode, this time concerning the modification of existing applications.

In the browser window 1, using the aforementioned plug-in, the user has chosen or been led to choose one or two existing applications selected from the applications server site. His intention is to build a new application from elements of two existing applications. At least one of these two applications, or one of their sub-frames, could be the application described in FIG. 1. In this example, the two applications contain several sections and constitute the starting point. These applications are shown side by side in the browser window 1 in the form of respective frames 3 and 4. Each frame has three sections, in the form of scrollable lists for example, one of them involving travel destinations 31 (with photo, description, price), flight schedules 32, and hotel reservations 33, and the other involving music festivals 41, theater performances 42, and train schedules 43.

By selecting one of the frames (4 for example) and the “Change” button 1b, a prototype application window or “application frame” 2 is displayed. As a starting point, this copies the three frames of the original application 41, 42, 43, which become 21, 22 and 23. The user then decides to replace section 21 (formerly 41) with section 31 of frame 3. This is done by simply dragging and dropping it into frame 2. In addition, the user decides to add section 32 by dragging/dropping it from frame 3 to frame 2, the newcomer being placed between sections 21-22 and 23. The dimensions of these sections are reduced in size by automatic style changes and they are moved apart to make room for the new section 24. All these automatic operations are achieved by interactions between the applications server and the browser plug-in, by exchanging data and commands transparently to the user who only had to perform a simple drag and drop. This operation allows fully indicating the source sub-frame 32 within the frame 3, the destination frame 2, and the destination location between sub-frames 21, 22 and 23. The automatic style changes and resizing result from the characteristics of the frames, which are all known to the applications server.

One can easily deduce how the user modifies one of the basic component applications of the application 2: he simply selects it and the scenario described in relation to FIG. 1 proceeds as described above: The web pages pointed to by this basic application can then successively appear in the window 1. Saving the changes to a component application is followed by a return to the more general application that contains this component, and so on until the modified more general application is saved.

The simplicity of the procedure is therefore maximized from the user's point of view. This simplicity results from the division and distribution, according to the invention, of functions that interact between the server and the browser plug-in.

These operations are described below.

FIG. 3 shows the general architecture of the system used for the invention and in particular for carrying out the usage scenarios described above. This figure shows two chains: a chain for application creation and modification, and a chain for application execution. These share common elements.

First, the chain for application creation and modification is described below:

The user who wishes to create or modify an application has available to him a computer 100 comprising a browser 101 (at least one of the existing browsers) and an plug-in 102 specifically designed to interact with the applications server 200 via the Internet 1. This plug-in 102 is assumed to be already integrated with the browser, either by the manufacturer during the computer production process, or by the user, for example when logging into and subscribing or registering with the applications server site, in order to obtain the necessary resources and authorizations. The server 200 consists of a plurality of subsets detailed below.

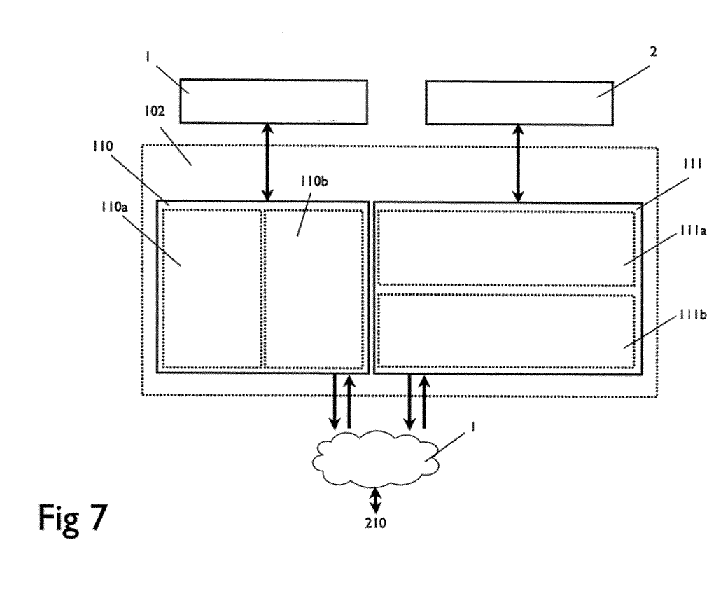

According to one possible embodiment, this plug-in can advantageously be implemented in the Javascript language and downloaded by the applications server site. Implementation details for this plug-in are given below in relation to FIG. 7.

According to another embodiment, the plug-in and the browser can form a single integrated application 103, dedicated to this purpose.

According to the first operating mode (FIG. 1), launching the plug-in 102 causes a change to the Internet connection parameters of the computer 100, such that all connections (requests and responses) to information sites 300 are redirected through the applications server denoted with the reference 200, and more specifically through a recording server 210 that also performs the application recorder functions.

This redirection is achieved by a simple modification of browser settings. The connection between the computer 100 and the server 210 is then protected as a link within a LAN and under the complete control of the server 210.

For simplicity, one can say that this plug-in offloads processing operations from the plug-in to the server 210, so that only the interactions with the user and the display functions remain on the user's computer.

The plug-in 102 also opens a so-called “application frame” window (like the window 2 of FIGS. 1 and 2, but not represented in FIG. 3) where the user progressively constructs the application he wishes to use later on. The user actions in the browser window and in the application frame are sent to the server 210. The processing performed after these actions is done by the server which, in return, directs what is displayed within this window and frame.

The application is created by analyzing the natural clickstream through the web pages on the website 300 from the browser 101. The component elements of the application being created are captured automatically, according to the invention, by functionalities added to the browser by means of the plug-in 102 in interaction with the server 210.

For example, the position of the part of a web page that is visible within the frame, a selection of a text field or an image, are sent to the server in the form of an index in the page's source code.

This plug-in 102 also provides the user with functions for initializing, selecting, modifying, and ending the recording of an application, as well as other functions such as those previously listed in the description of FIG. 1. Once the recording has started, the application is automatically created in the server 200 as a file containing records characterizing the application template, the target devices, and the objects to be presented by the final application when it is executed.

This application file is advantageously saved in a database 220, as database technology is better suited for organizing records so that the applications can be shared by a large number of users.

The Select function provides the means for selecting not just simple data but metadata, meaning the description and location of the data. The data may be a string of characters, an image, a video, a link to another page, etc. With each selection, the system uses relevant criteria to identify how to find the data on the web.

This server stores in the database 220 not only the metadata selected, but also the bot(s) and agent(s) that will reproduce the entire user clickstream on the web between the start and end of recording, meaning at the very least the browsing history of the user.

He can thus browse as naturally as possible, and when he wants to select data the system provides a metadata capturing function that can advantageously be a selection box on the displayed page or any other form of selection according to the conventional user interface provided by the computer manufacturer. The displaying of this selection box within the browser window is a function of the plug-in 102. Extraction of the metadata corresponding to the selection box is a function of the server 210 which has cached the entire page displayed by the browser and which, due to the selection, is able to determine the portion of the HTML, XML, or other code that corresponds to this selection, as well as the location information (at least the page URL and position on the page), to allow accessing it later on.

The possibility and the representation of dragging/dropping to position the selected data in the application frame is another function of the plug-in in interaction with the server 210. The metadata are recorded when the selected data are dropped into the application frame.

The user actions in the browser window are therefore sent to the server 210, and associated with the parameters of the selected data and extracted so that the server can specifically identify the corresponding metadata and their integration into the application by saving these metadata in the database 220.

The server 210 thus functions as a recorder with a “start recording” action and a “stop recording” action. Between the two, “capture” actions are represented by records in the database 220.

The extraction system therefore defines a metastructure that can be copied/pasted or dragged/dropped into the application frame. Once dropped into the application frame (view, page, etc.), the collected structures are displayed in an appropriate component (table, list, gallery, etc.) that is part of the definition of the initially selected template.

A final application therefore consists of one or more such components.

An application can also be a component.

An application can also be an assembly of other applications.

This application frame may be used to prepare the application for redistribution on multiple platforms (computer, mobile phone, tablet, TV, etc.) that can impose variants in the presentation of the same content (font sizes and types, number of characters per line, scrolling and zooming, etc.).

This frame allows displaying a rendering of the metadata, meaning how the data defined by the metadata will be viewed by the user after redistribution. The user thus creates an image of how he wants to use what he has captured and recorded.

For this purpose, graphical tools are provided which are applied to each metadata and therefore concern all data linked to this metadata.

The selection function offered by the plug-in, in combination with and in relation with the recording server 210, allows it to identify not only the data being viewed at the moment, but also the future data located at the same place in the page or in another page with a similar structure.

In the case of a simple selection, as represented in FIG. 1, the selection of an item by the user causes the creation of the corresponding metadata. By a simple copy/paste or drag/drop, moving the selection to the application window is translated by the server 210 into a link between the metadata and the component that will display it or use it in the new application. Selection is facilitated by visually indicating the current selection by highlighting, blinking, sparkling, silhouetting, framing with a box, or any other equivalent visual method.

The saving of metadata may also involve saving multiple other metadata associated with the selected metadata, even if they are not visible. This is the case for web pages consisting of a list of simple or complex data. An example would be a product catalog in tabular form where each cell describes a product. The user may want to capture all data for all products by simply selecting one product. To do this, the user can use a special “Multiple selection” button which then launches a technical means for automatically selecting data similar to the selected data, to be associated with the same metadata.

The selection function therefore has a “multiple” option which, when selected, indicates to the plug-in 102 and to the server 210 that it must make use of a structure comparison module and a search and analysis bot to process the visited site. This way, the user does not have to select each occurrence manually. This is particularly useful when their number varies from one page to another.

Similar metadata may also originate from a means for searching for semantic analogies either in the same site or in other sites on the web. These analogy searches can be encountered in the case of images or data hidden behind the selected metadata and therefore not seen by the user.

Once the recording is ended, the server 210 has saved in the database 220 a series of records corresponding to the desired content and information, in the form of metadata, as well as one or more agents capable of reproducing the user's clickstream, and a presentation template that will allow displaying the metadata on various platforms, for example static or dynamic backgrounds, existing software modules (spreadsheet, calendar, maps, games, . . . ).

In practice, the hierarchy between agents, bots, and metadata is expressed by the agent controlling bots that perform tasks described by the metadata.

The recording server provides these data structures to the application for later access independently of the pages containing them. The database 220 is therefore shared by the recording server 210 for creation/modification operations and by the application execution server 240 which is described below.

The recorded application can be for individual or collective use. The architecture of the system according to the invention allows sharing applications with other users who in this case have access to some or all of the application frame and its functionalities, depending on the related authorizations.

The application execution chain will now be described below:

When the user wants to use the application from a device 110, he has to have previously downloaded an execution module 105 by connecting to the site of the applications server 200. This connection can occur in various ways: by entering the server address in the browser or via a link in a web page, an email, or some other application. Accessing an application may include steps of registering with the site, the site services (such as application creation), and access controls (id and password).

Due to the different natures of the devices, according to the invention, the execution module 105 is specific to the device or to a class of devices, particularly to the operating system, to the screen resolution, its size, and the characteristics of its means of interaction. A small screen cannot display as many application components as a large screen. The presentation may therefore differ from one device to another, and the applications server is responsible for making the necessary adjustment based on the knowledge it acquires concerning the device type upon connection between the module 105 and the server 200. Such adjustment techniques are well known and are already implemented in browsers and websites.

According to a feature of the invention, the saving of the metadata in the database and the extraction of the data are independent of the devices. Only the rendering of the data corresponding to these metadata can be customized to the device. To do this, the recorded application includes a part describing the application presentation that is tailored to the characteristics of the devices, either when saved in the application database or when downloaded to the device, or both at once. The elements necessary for presentation on a given device are preferably determined at the time the application is downloaded or at the time the data is sent by the server. This is in fact the template chosen at creation, in which the rendering of the metadata can change according to the type of device and user preferences.

It is a generic application, independent of the data, metadata, and their representation, which is executed on the device (and therefore dependent on its hardware and operating system). The device manufacturers usually provide tools for developing such applications. Due to the independence between applications and data, a single generic application can support many saved application templates, which allows displaying many types of data with varying functionalities and different subjects. A set of templates associated with a generic application can thus be sufficient to support a wide variety of applications supporting all kinds of data.

On the user side, the application 105 sends the server 240 a request to download the application description. Once downloaded, this contains a list of agents that the application runs. These agents then send bot-launching commands to the server. These bots execute queries on the Internet in accordance with the metadata they contain. The data received in response then reach the application which presents them to the user progressively and asynchronously, according to said description. More details are provided in relation to FIG. 7.

The downloaded application 105 may be a browser module or may be created using browser technologies whose functions are limited to only those functions that are necessary, in order to reduce size and optimize performance. The application 105 may also be a “gadget” that can interpret commands and HTML and/or XML.

Other embodiments are given below which concern application receivers.

Optionally, a connection between the recording server 210 and the applications server 240 allows executing the application (all or part) during creation or modification in simulation mode, in order to provide a true representation of the application. In this case, the application 105 is run on the same device as the browser 101 and plug-in 102. This is then an application simulator or device simulator. It is possible to download multiple applications or simulators 105 corresponding to different kinds of devices (in particular to judge the rendering on different screen sizes which can influence the layout and readability of application components).

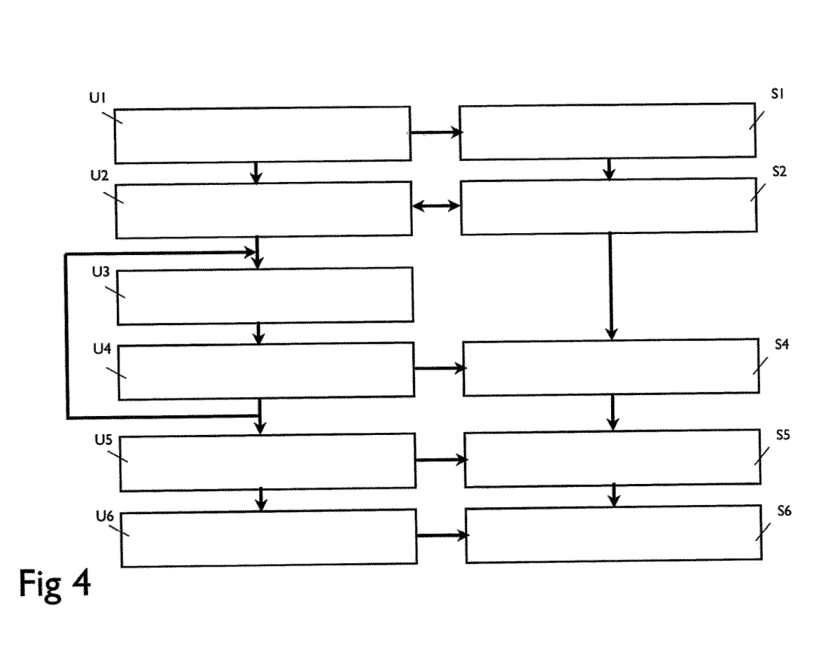

FIG. 4 shows an example of the steps of the method for application creation according to the invention.

Steps U1 to U6 on the left take place on the computer 100 of the user creating the application. Steps S1 to S6 take place on the applications server 200.

Steps U1 and S1: The browser and its plug-in are launched. This connects to the server 200 via the Internet. The redirection ensures that all traffic from the computer passes through the server 200.

Step U2: Before starting to search for data on the Internet, the user must select an application template from a set of predefined templates proposed by the server 200 (step S2). This is a step of defining a prototype and displaying the prototype window. The choice of template can take into account the target device or devices whose characteristics may include limiting factors or require variations in presentation.

Step S2: Creation of the application file in the database which will contain, among other things, the metadata records as well as the reference for the template selected in step U2.

Step U3: The user searches for information on the web from the browser window.

Step U4: The user finds information relevant to his application. He selects this information (for example by clicking the “Select” button and then drawing a box around the information) and then drags/drops it into the prototype window. He can also select a multiple selection button.

Steps U3 and U4 are repeated until the application creation is done.

Step S4: With each addition of information to the prototype in step U4, the server stores the metadata with the corresponding agents and bots.

Step U5: At the end of creation, the user issues a command to save the application.

Step S5: The server possibly enriches the list of recorded metadata with a search and recording of metadata for similar information, then ends the compilation of application data by conventional computer means.

Step U6: The rights management that allows sharing some or all of the application optionally requires querying the user in a questionnaire page.

Step S6: The system saves the rights management data, closes the application file, and makes it available for distribution and execution.

Other ways to create applications are possible and equivalent. In particular, it is possible to search first for all potentially relevant information (repeating the single step U3) and then provide only the relevant information to the user in the application frame (repeating step U4).

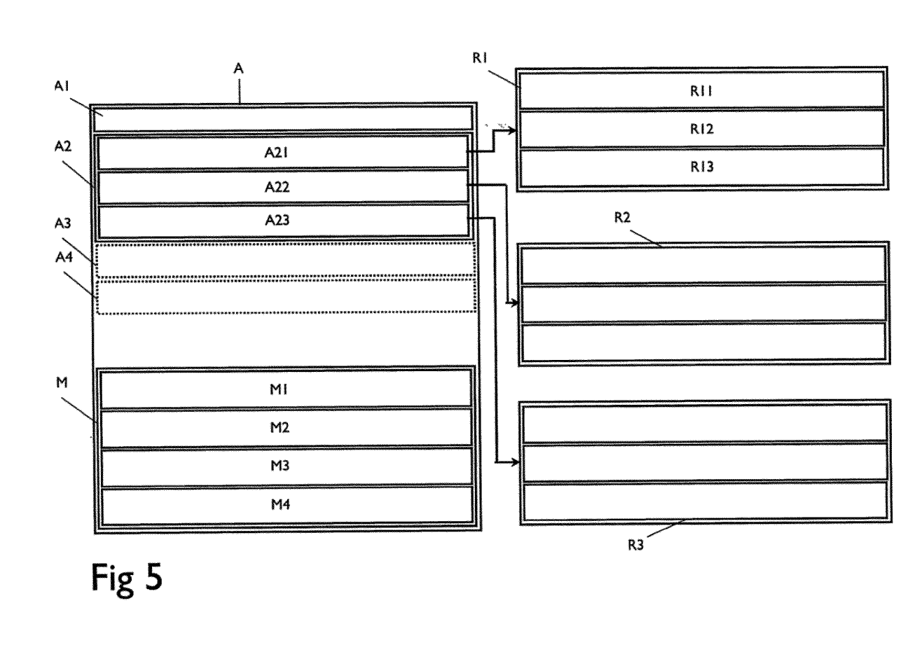

FIG. 5 symbolically shows an example of an application file A in the database 220. These are blocks of storage where the data recorded during an application creation or modification session were saved; these data are subsequently read and used by other system resources during execution of the application.

This file contains an application part and a bot-related part. As the bots may be shared by multiple applications, they are preferably separate but associated by links.

The application part (on the left in the figure) contains:
a part A1 that contains the application header (name, date, creator, rights, description, etc.) and the types of devices supported.
a description of the selected template M, which contains a series of characteristics M1, M2, M3, M4, etc. which may relate for example to text elements, grids and tables, graphs, multimedia, etc.
a series of agents A2, A3, A4, etc. which reference metadata and their bots, which can be divided into sub-agents (for example in a multiple selection) A21, A22, A23, etc. These agents point to the other part that concerns bots R1, R2, R3, etc. and groups of bots R11, R12, R13, etc. Each bot contains the metadata constituting the task it is to perform.
Bots are generally shared by multiple applications and are linked to applications via links or references. This shared structure reduces the amount of memory required, but also allows easily enriching and enhancing the applications as indicated above.

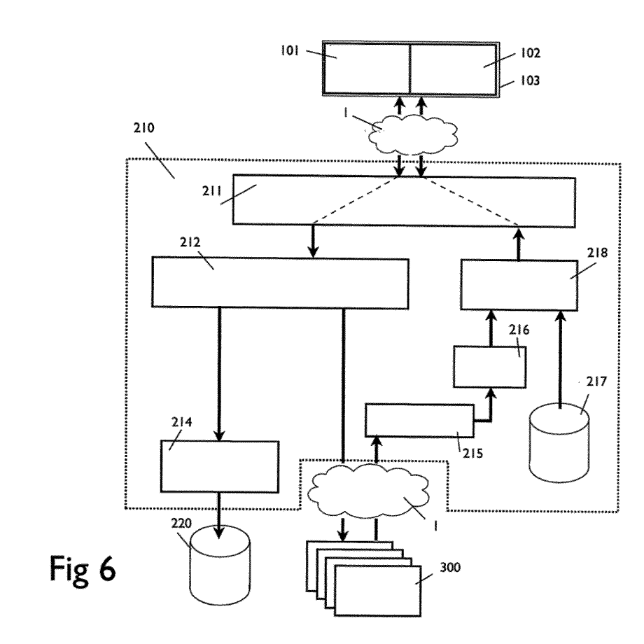

FIG. 6 shows the details of the implementation of the recording server 210.

Recall that this server is intended to allow analysis of the browsing performed by the user during the application creation phase, from the browser 101 and in interaction with its plug-in 102 by means of redirection of streams from the browser to the server 210. The server therefore “sees” all these streams as they pass through. The server 210 uses the technological functions required to analyze these streams and create recordings, meaning the steps of the method described in relation to FIG. 4, as well as automatic enhancement functions.

The recording server 210 comprises the following elements or modules:
A proxy server 211 that ensures the transition of all incoming and outgoing traffic (queries and responses) between the user's computer (via the network 1) and the rest of the system. It possibly acts as a cache, in particular to record the dynamic clickstream through various web pages, queries and responses, locations on the web (URL addresses), user actions performed on each page, in order to locate and extract relevant data structures that allow recording the metadata in the database 220. The proxy server is able to hear commands from the plug-in 102 that are not navigation commands.
A dispatcher 212 that separates the requests from the browser 101 intended for the visited site 300 being analyzed by the user, from the requests from the plug-in 102 intended for application creation (templates, metadata and agents). It separates out the requests that do not originate from elements of the visited page but which come indirectly from the toolbox 216, via the plug-in 102. Requests such as creating a new application, selecting an application frame template from those proposed in a database of templates 217, creating an agent, saving it, selecting metadata, modifying or deleting the metadata, etc. are identified by a tag in the request and are rerouted to the agent/metadata recorder 214.

Objects intended for application creation are then sent to:
a recording module 214 for agents, bots, and metadata corresponding to the data selected by the user to be part of the target application, which saves them in the applications database 220. This module therefore makes these data structures available to the application so that it can later access them independently of the web pages that contain them.

The responses returned from the site accessed via the network 1 are successively processed by:
a filtering and standardization module 215 that ensures consistency between the pages displayed by the browser 101 and the processing done by the recording module 214, so that, when executed, the reconstruction is identical to the original. It allows, among other things, blocking certain spurious messages and some dynamic scripts. It thus handles the analysis and breakdown of visited pages to identify their data structure and their display template. This operation is extended to pages similar to the visited site, for example in order to allow multiple selections and automatic enhancements using existing bots and metadata in the database, which may originate from other users. For example, if the page in question has never been visited (this is the first time) and is not known to the server, then the page is reconstructed as it is in the browser. On the other hand, if the page is known to the server and is already associated with a bot (with metadata), then the module 215 analyzes this page and adds to the page some references to the metadata which are then displayed by the plug-in (using tools of the next module 216): the user will then see, for example, the appearance of a preselected object. If this selection is relevant to the user, he only needs to drag and drop it in order to add it to his application, which saves time and increases simplicity.
a “toolbox” 216 which is present in the form of an injector for adding graphical and semantic functions to the response document, particularly to ensure the selection of metadata. It adds, for example, graphical commands and interactivity elements which are used by the plug-in 102 and the browser 101 in the mechanisms for data selection and identification by the user. This toolbox is provided in the form of a library of Javascript functions. One or more functions are selected, according to the context, for insertion into the data stream returned to the browser-plug-in ensemble 101-102.
a module 218 for formatting the pages accessed, particularly to integrate the toolbox functions into the response page and to integrate the tags used by the dispatcher module. It can also be based on the characteristics of the template which are also extracted from the template database 217 to be sent to the plug-in 102 and to enable appropriate display of the extracted data on the user's creation workstation 100.

FIG. 7 shows an embodiment of the plug-in 102 of the browser 101.

The plug-in contains two main modules 110 and 111. Module 110 is dedicated to management of the browser window 1, and module 111 to management of the window of the application frame (one or more) 2.

Module 110 comprises two types of tools: selection tools 110a which are displayed in the page for indicating the selection, and command tools 110b such as the buttons defined and described in relation to FIGS. 1 and 2.

Module 111 comprises two subsets: module 111a which controls the application frame(s) by displaying them via functions offered by the operating system of the computer, as a standard application would; and module 111b which handles the choice of type of interface between the agents and the device (for all types of devices), by acting as interface between the server 210 and the application frames management.

In general, the application interfaces of the applications that can be produced according to the invention are not limited to touchscreen/keyboard/mouse types of interfaces (for computers, tablets, phones), but also incorporate voice, sound interfaces and in general can make use of all kinds of sensory devices for acquisition and rendering.

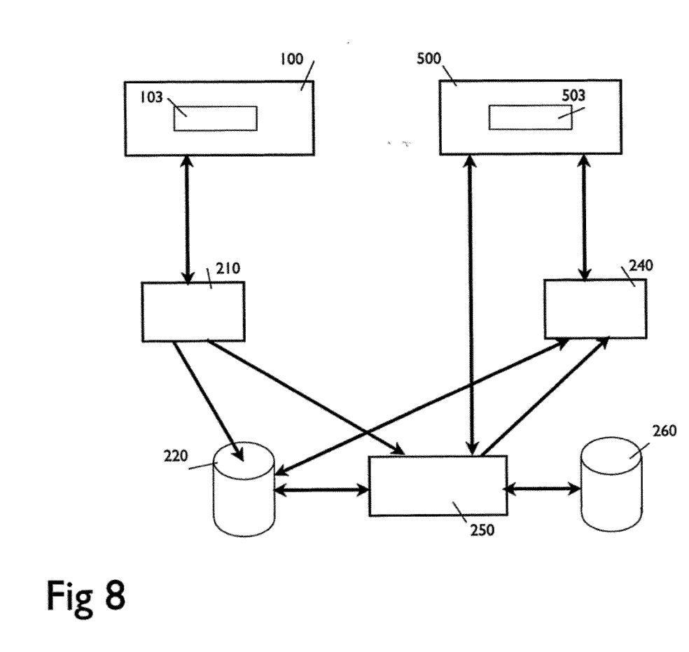

FIG. 8 represents a complete system according to the invention, further comprising a system for managing subscribers and subscriptions.

As described in relation to FIG. 3, the creation or modification workstation 100 is connected via the Internet (not shown) to the recording server 210 which supplies data to the applications database 220. Via the server 210, in its role as proxy, the creating user is also connected to a subscriber server 250 that manages subscriptions, and more generally subscriber spaces, in a subscriber database 260. This allows grouping different services associated with subscriptions such as identifiers and access permissions (name, user id, password, e-mail address, etc.) and usage permissions (access to some or all applications of the database 220, list of applications belonging to the user and pointers to these applications in the database 220 for use or modification, management of sharing with other users, copyright management, management of fees and online payment tools).

Similarly, in order to run an application on a device 500, connecting the device to the execution server 240 and accessing the applications database 220 requires an authenticated connection to the subscriber server 250, then selecting an application authorized for the device and downloading the required modules as explained above.

Since it is possible to share applications under certain technical, legal, and commercial conditions managed by the subscriber server 250 according to certain terms of use, the organization of the records in the applications database is designed so that elements shared by applications are not duplicated.

The technical implementation of the components of such a “client-server” pair relies on known technologies that are within the reach of a person skilled in the art.

In particular, the recording servers 220, execution servers 240, subscription servers 250, and the associated databases can be constructed in centralized or distributed form, and can use any known forms of communication between components.

Moreover, it is also possible to offload a small portion of the processing done by the above servers to each device or to some of the devices, especially those that are always or almost always connected to the network. “Port to port” technologies are well suited for this.

The invention has many applications in the development of increasingly faster web technologies. It applies in particular to owners of devices connected to the web, millions of whom are finding more and more useful and relevant services for their devices. With the invention, each user will be able to design the application(s) for obtaining the service(s) they want. The success of the first devices of this type and of the application stores dedicated to them have already confirmed that an even simpler chain of application creation and distribution according to the invention will provide even wider, rapid, and significant dissemination of commercial developments.

The invention is applicable not only to the mentioned devices for receiving and running applications (computers, tablets, phones, televisions, etc.), but also to machines with different interfaces for acquisition and rendering, possibly even without a user interface or human interaction interface, as can be found in distributed “machine to machine” architectures dedicated to executing certain tasks determined by external data. In this case, these machines can be considered as equivalent to what is described above, in that the user interface is still present even if it is provided remotely on one or more other machines.

In addition, for application creation, the invention is also applicable to distributed “peer to peer” architectures making use of networked computers instead of (or in addition to) centralized servers, these two types of architecture being considered functionally equivalent. As indicated above, the technical architecture presented can be broken down differently, for example in a distributed rather than centralized manner, notably to ensure widespread deployment of services according to the invention.

The invention further proposes, according to certain embodiments, a method for developing a custom application for accessing web content and services on various devices, from a personal computer operated by a user and connected to an applications server, characterized in that it comprises the following steps: choosing, on the computer, a prototype application frame template designed to display information and content according to a chosen presentation on one or more devices, and starting up a recording session by the following two iterative operations: searching the web by the user to find information of the desired type, selecting and placing this information in predefined fields of said application frame, capturing the metadata corresponding to the selected information and content in response to user actions, successively recording these metadata in a database in the form of one or more agents capable of reproducing the user clickstream, with presentation data suitable for said application frame, finishing the recording session by grouping in the applications server the agents, the presentation characteristics, and the application frame template, in a data structure called an “application”, ready for distribution and execution on at least one type of device.

The invention further proposes, according to certain embodiments, a method for executing a custom application created by the above development method, comprising the following steps: launching an application execution program on the device, which can be either pre-installed or downloaded, connecting this execution program to an applications server in order to select, download, and launch the application which requests data from the server and handles displaying these data and interactions with the user on the device and the extraction of data on the web by the server, controlling, in response to user actions, via the applications server, the agent or agents saved in the application in order to extract the corresponding data from the web, filtering, adapting to the presentation template of the application, the data retrieved by the agents, and forwarding them to the execution program which presents them to the user on the device.

One advantage of the invention results from the combination of two distinct but interacting parts of the application: one part, resident on the device (after downloading, where appropriate), that handles the specific characteristics (functionalities and limitations) of the device, user interactions, and which requests the data from the server; and one part on the applications server, that handles data management and sending data to the device. This subdivision guarantees in particular that an application can be run on a large number of device types, as customization mostly occurs in a small portion of the whole: the execution program and possibly the application template. The data and content are then automatically adapted to the template.

The invention further proposes, according to certain embodiments, a system for developing custom applications which makes use of the method for developing custom applications described above, comprising, in combination, for the application creation, a browser paired with a specific development plug-in, pre-installed on a computer, allowing the user to build an application for one or more destination devices, using, on the one hand, a selected application template or subsets of existing applications, and on the other hand, information or content searched for and located on the web with the browser, this plug-in including means for redirecting requests and responses from the browser to a recording proxy server then, on the one hand, capturing and sending to said server actions made by the user to select data or content in a browser window, and on the other hand, displaying at least one window of the application template which presents the information selected and dragged from the browser window to this template window, as well as the interactions between said server and the user actions, a recording proxy server that comprises the implementation, during a development session, of means for sending requests to the websites chosen by the user and capturing the responses, means for identifying, extracting, and recording, in an applications database, agents and metadata corresponding to the information selected by the user, these saved recordings, combined with the application template for the target device or devices, constituting an application at the end of the creation session, an applications database grouping said recordings and the structures of the presentation template for the purposes of execution by at least one device.

Through these arrangements, user development actions (creation or modification) are carried out and automated by the proxy server which automatically “learns” the user requests and records the overall results in a file containing the agents and the metadata associated with one or more data presentation templates. In this manner the application can be subsequently “replayed” on different types of devices.

In addition, the recordings saved in response to the user selections can be enriched with supplemental recordings similar to those described above when the web pages visited or the metadata database contain similar structures. The applications can thus be enriched with the wealth of pages, sites, and recordings existing in the applications database, particularly due to the presence of existing applications from the same user or from other users when sharing is allowed.

The invention further proposes, according to certain embodiments, a system for executing an application created by the method for executing an application described above, and the application development system described above, comprising an interactive display application that is already resident or downloaded to the user device, able to connect to the applications server, request a specific application, and handle displaying the information sent by the applications server as well as user interactions, in accordance with criteria which are described in the application, an applications server capable of storing and downloading at least one application to a connected device, comprising means for controlling the agent or agents read in the application file and provided for extracting data from the web, interacting with the user via the display application on the device, a set of agents and bots for performing said extraction of data from the web, and means for filtering and adapting the extracted data according to the presentation template described in the recording and for sending them to the display application on the device.

In certain embodiments of the application development system described above, the recording server also comprises means for automatically capturing additional metadata corresponding to data of the same or similar type as the data selected by the user, in the same page of the visited site as well as in other pages of the site.

In certain embodiments of the application development system described above, the recording server comprises means for sharing metadata and/or some or all of the applications database between users, to enable sharing applications, when such sharing is allowed, for the creation/modification and execution of applications.

In certain embodiments of the application development system described above, the plug-in comprises a module (111b) for interfacing between the different types of agent for managing the applications metadata and the various interface technologies for acquisition and rendering provided on the target devices of the applications.

In certain embodiments of the application development system described above, the paired browser and plug-in are in the form of an integrated development application.

In certain embodiments, the application development system described above further comprises one or more application simulators in accordance with the execution system described above.

In certain embodiments, the application development and execution system described above further comprises a user subscription server, a database of users and user spaces, and means for sharing applications between users according to the relevant rights.

In certain embodiments, the application development and execution system described above comprises a means for finding semantic analogies of metadata in order to augment the automatic extraction of metadata during creation or modification of an application.

With these arrangements, the application data do not reside on the device which only contains a module for displaying and user interaction, nor do they reside on the applications server which only contains agents, bots, and metadata, but it still benefits from all the resources, performance, updates, and enhancements available to it. The extracted data can be of any type (text, images, video, sound, interactivity elements, etc., as described below in the definition of the word “metadata”).

Advantageously, optimum performance is thus obtained because only the dynamic data needed for the current interactions and display are sent. The static data, which are small in quantity and volume, are built into the application at creation.

With these arrangements, user efforts to find relevant information on a recurring basis need only be made once, during creation or modification of the application. The information is then accessed automatically at execution according to the interactions between user and application.

In addition, the more complex part, which is the search and retrieval of information on web sites, is no longer done directly by users but is done automatically by the server which is shared by all the users and is designed to support all the necessary technologies and upgrades, at a normally better performance than that of the accessing devices.

Advantageously, users can benefit from the enhanced information as described above because the enhancements are done on the server and are much easier to modify than updating an application on the device.

In particular, users are not limited to building applications based only on information found on the web; they can also make use of some or all of the existing applications and can combine them differently or enhance them with other types of information. They thus benefit from the data targeted by these other applications.

In addition, enhancements can be proposed and integrated directly by the server, either during creation or modification, or during execution. These may be deduced from communications between the bots handling queries and extractions, or may be induced by applications specifically developed for this purpose on the server.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A method for developing an application for accessing, on a device provided with a display screen, content and services accessible by browsing the web, from a computer operated by a user and connected to an applications server, said method comprising:
capturing, in response to the selection by the user of information and/or content on the web during a web clickstream, metadata comprising data description and location information and corresponding to the selected information and/or content, and recording said metadata, and
grouping, in a data structure of the application, the metadata, a software agent capable of extracting information and/or content from the web on the basis of the metadata, and presentation data for the information and/or content extracted from the web.

2. The method for developing an application according to claim 1, further comprising: recording a web clickstream of the user, and wherein the software agent is adapted to reproduce the recorded clickstream.

3. The method for developing an application according to claim 1, further comprising: selecting from among a plurality of presentation templates an application frame designed for displaying, on the display screen of the device on which the application is executed, information and/or content extracted from the web, and wherein the data structure of the application comprises the application frame selected.

4. The method for developing an application according to claim 1, further comprising:
executing an application execution program on the computer,
establishing a connection between the application execution program running on the computer and the applications server,
executing the software agent saved in the data structure of the application in order to extract the information and/or content selected by the user during his clickstream on the basis of the application metadata,
adapting, according to the presentation data associated with the application, the information and/or content extracted by the software agent, and
displaying the adapted information and/or content on the display screen of the computer.

5. An application development system comprising:
a computer comprising a processor and a memory coupled to the processor,
a recording server coupled to an applications database,
wherein the memory stores a set of software comprising a web browser and a specific development plug-in for the browser for developing an application intended to be run on a device provided with a display screen,
wherein the specific development plug-in for the browser comprises instructions for performing: (i) the capture and transmission to the recording server, in response to the selection by a user of information and/or content on the web during a web clickstream, of metadata comprising data description and location information and corresponding to the selected information and/or content, and
wherein the recording server is configured to execute software comprising instructions for, during an application development session, receiving and recording metadata corresponding to the information and/or content selected, generating a software agent capable of extracting information and/or content from the web on the basis of the metadata, receiving and recording presentation data for the information and/or content extracted from the web, and grouping and saving in a data structure of the application the metadata, the software agent, and the presentation data.

6. The application development system according to claim 5, wherein the specific development plug-in for the browser further comprises instructions for redirecting, to the recording server, navigation requests and responses from the browser corresponding to the user clickstream, and wherein the software of the recording server further comprises instructions for recording is user clickstream on the web.

7. The application development system according to claim 5, wherein the software of the recording server further comprises instructions for capturing metadata corresponding to data of the same or similar type as the data selected by the user, in the same page of the visited site, as well as in other pages of the site.

8. The application development system according to claim 5, wherein the software of the recording server further comprises instructions for sharing metadata and/or some or all of the database applications between users, in order to allow sharing between applications between users for the creation/modification and for the execution of applications.

9. The application development system according to claim 5, wherein the specific development plug-in for the browser comprises a module for interfacing between the different types of software agent for managing the applications metadata and the various interface technologies for acquisition and rendering provided on the target devices of the applications.

10. The application development system according to claim 5, wherein the set of software that is the browser and the specific development plug-in for the browser is an integrated development application.

11. The application development system according to claim 5, further comprising a user subscription server, a database of users and user spaces, and means for sharing applications between users according to the relevant rights.

12. The application development system according to claim 5, further comprising a mean for finding semantic analogies of metadata in order to augment the automatic extraction of metadata during creation or modification of an application.
